(19) United States
(12) Patent Application Publication
(10) Pub. No.: US 2006/0087556 A1
(43) Pub. Date: Apr. 27, 2006

(54) Stereoscopic image display device

(76) Inventor: Kazunari Era, Kashiwa-shi (JP)

Correspondence Address: OLIFF & BERRIDGE, PLC, P.O. BOX 19928, ALEXANDRIA, VA, 22320, US

(21) Appl. No.: 11/208,853

(22) Filed: Aug. 23, 2005

Related U.S. Application Data
(60) Provisional application No. 60/620,334, filed on Oct. 21, 2004.

(51) Int. Cl. H04N 13/04; H04N 15/00

(52) U.S. Cl. 348/51

(57) ABSTRACT

A device that from flat image data creates image data with which a portion of those flat image data can be viewed in three dimensions, and that allows the image to been seen three-dimensionally by a viewer, is provided. A CPU reads a flat image file from a HD and displays that flat image on an image display liquid crystal of a display portion. When an operator performs a drag-and-drop operation to specify a region that he would like to view in three dimensions from that flat image, the CPU performs stereoscopic presentation processing on the pixels of that region and then writes the synthetic parallax image that is obtained by performing that stereoscopic presentation processing over the flat image. The flat image over which the synthetic parallax image has been written is then again displayed on the image display liquid crystal.

### BACKGROUND OF THE INVENTION

1. Field of the Invention

The present invention relates to stereoscopic (3D) image display devices that create and display stereoscopic image data from a file that describes flat 2D image data.

2. Description of Related Art

One stereoscopic projection method that allows a viewer to perceive stereoscopic images without wearing equipment such as complementary spectacles or polarization spectacles is a method known as parallel viewing with naked eyes. With parallel viewing, a synthetic parallax image is created by arranging, in alternating rows, pixels in stripe-shaped groups obtained by partitioning a left eye parallax image and a right eye parallax image that have parallax with respect to one another, and this synthetic parallax image is output from a display element. A portion of the viewer's field of view is blocked using a mechanism such as a lenticular lens or a parallax barrier so that the image fragment of the left eye parallax image and the image fragment of the right eye parallax image that are incorporated by the synthetic parallax image are delivered to the left and right eyes, respectively, thereby creating a stereoscopic presentation. The method of blocking a portion of the field of view using a lenticular lens is known as the lenticular method, and the method of blocking a portion of the field of view using a parallax barrier is known as the parallax barrier method.

A synthetic parallax image used for parallel viewing is generally created by synthesizing a number of images captured separately at different viewing angles through the above procedure, but synthetic parallax images are also created from a single original image data unit captured at a single viewing angle. A method for generating such synthetic parallax images is disclosed in JP 2002-123842A. This document discloses a technology of performing processing such that near and far portions in an image are segregated based on depth values calculated from the vividness of the pixels of that image (or from the values calculated by performing a predetermined correction of those depth values), and in the left eye parallax image and the right eye parallax image a larger parallax is calculated for the near portions than for the distant portions. The rule of thumb that the background generally drops in vividness as the depth increases and rises in vividness as the depth decreases is employed in an algorithm for calculating depth values from the vividness of the pixels.

Sometimes when creating stereoscopic 3D images one would like to provide some of the image as a stereoscopic presentation and have the remaining image stay as a flat 2D image. An example of one such case is a situation in which it is desirable to make only specific letters in an image three-dimensional in order to draw the viewer's attention to those letters only. However, in the prior art typified by JP 2002-123842A, one cannot find discussion of technology that allows for the easy creation of data of an image that is three-dimensional only partially from the data of a flat 2D image.

### SUMMARY OF THE INVENTION

The invention has been proposed in light of these conditions and provides a device that from flat image data creates image data in which a portion of that flat image can be provided as a stereoscopic presentation and moreover that allows that image to be presented as a stereoscopic image to a viewer.

To address the above issues, a first aspect of the invention is a stereoscopic image display device that is provided with a creation section that creates a stereoscopic image, a synthesis section that writes the stereoscopic image over a flat image, synthesizing the two images, and a display section that outputs the synthesized image.

A second aspect of the invention is a stereoscopic image display device that is provided with a memory section storing flat images, a creation section that creates a stereoscopic image of a specific region of a flat image that has been read from the memory section, a synthesis section that writes the stereoscopic image of the specific region over that specific region in the flat image, synthesizing the two images, and a display section that outputs the synthesized image.

A third aspect of the invention is the stereoscopic image display device according to the second aspect, further provided with a designation section that designates a specific region in the flat image. Furthermore, the creation section creates a stereoscopic image of a specific region of the flat image that has been designated by the designation section.

A fourth aspect of the invention is the stereoscopic image display device according to the second aspect, where the creation section detects a region in which a specific object is displayed in the flat image, and creates a stereoscopic image of that detected display region. Furthermore, the synthesis section writes the stereoscopic image of the region in which that specific object is displayed over the flat image that has been read, synthesizing the two images.

A fifth aspect of the invention is the stereoscopic image display device according to the fourth aspect, in which there are a plurality of the regions in which a specific object is displayed in the flat image.

A sixth aspect of the invention is the stereoscopic image display device according to the third aspect, where the creation section creates the stereoscopic image by converting the specific region of the flat image into a right eye parallax image and a left eye parallax image that have parallax with respect to one another and then arranging, in alternating rows, stripe-shaped pixel groups obtained by partitioning the right eye parallax image and the left eye parallax image.

A seventh aspect of the invention is the stereoscopic image display device according to the fourth aspect, where the creation section removes pixels residing in a predetermined region at both ends of the stereoscopic image that is created.

An eighth aspect of the invention is the stereoscopic image display device according to the fourth aspect, where the creation section causes a color of pixels residing in a predetermined region at both ends of the stereoscopic image that is created, to be a uniform specific color.

A ninth aspect of the invention is the stereoscopic image display device according to the fourth aspect, where the creation section causes pixels residing in a predetermined region at both ends of the stereoscopic image that is created to become transparent.

A tenth aspect of the invention is the stereoscopic image display device according to any of the sixth through ninth aspects, further including a view field blocking section that blocks a portion of a field of view of a left eye such that the right eye parallax image, which is incorporated as stripes in the stereoscopic image, is formed only on the right eye, and blocks a portion of a field of view of a right eye such that the left eye parallax image is formed only on the left eye.

An eleventh aspect of the invention is the stereoscopic image display device according to the tenth aspect, further including a control section that controls the operation of the view field blocking section such that a region in which a portion of the field of view is blocked matches a specific region of the flat image that has been designated.

### BRIEF DESCRIPTION OF THE DRAWINGS

FIG. 1 is a block diagram showing the configuration of an embodiment.

FIG. 2 is a diagram showing the positional relationship among the main elements of the display portion.

FIG. 3 is a diagram showing the principle of stereoscopic representation using a parallax barrier.

FIG. 4 is a flowchart showing the operation of the embodiment.

FIG. 5 is a diagram showing the main screen.

FIG. 6 is an example of a flat image.

FIG. 7 is a diagram showing the operation for designating a stereoscopic presentation region.

FIG. 8 is a diagram showing the processing for correcting the ends of the synthetic parallax image.

FIG. 9 is a diagram showing the processing for overwriting with the synthetic parallax image.

FIG. 10 is a diagram showing the positional relationship among the main elements of the display portion.

FIG. 11 is a flowchart showing the operation of the embodiment.

FIG. 12 is an example of a flat image.

FIG. 13 is a block diagram showing the configuration of a modified example.

### DETAILED DESCRIPTION OF THE INVENTION

Embodiments of the present invention are described below. It should be noted that the invention is not limited to the following embodiments, and substitutions thereto by technical means normally employed by those skilled in the art are possible.

### A FIRST EMBODIMENT

<Configuration of the Embodiment>

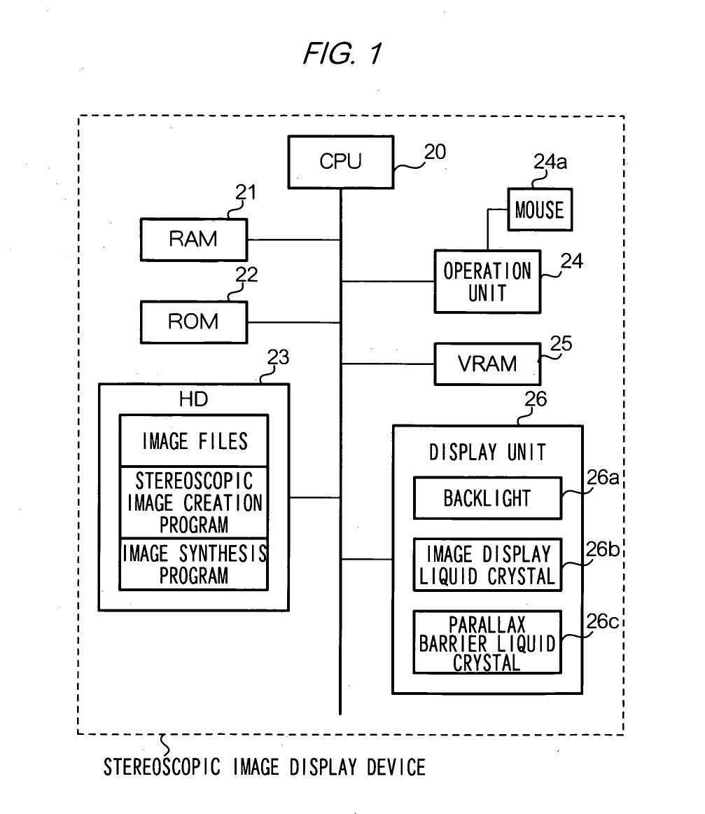

FIG. 1 is a block diagram showing the configuration of the present embodiment. As shown in this drawing, a stereoscopic image display device of the embodiment is provided with a CPU (Central Processing Unit) 20, a RAM (Random Access Memory) 21, a ROM (Read Only Memory) 22, a HD (Hard Disk) 23, an operation unit 24, a VRAM (Video RAM) 25, and a display portion 26.

The CPU 20 performs control of the overall operation of the device. The RAM 21 is a volatile memory element that provides a work area for the CPU 20. The ROM 22 is a non-volatile memory element that stores a program for governing the basic controls of the various sections of the device, such as an IPL (Initial Program Loader). The HD 23 is a magnetic disk that, in addition to the operating system, stores image files that store images, a stereoscopic image creation program that executes the operations characteristic of the present embodiment, and an image synthesis program, for example. The operation unit 24 is a keyboard, and is further provided with a mouse 24a that functions as a pointing device. The VRAM 25 is a memory element that obtains from the CPU 20 and temporarily stores, the A (alpha) R (red) G (green) B (blue) values of each pixel address making up the image. When the CPU 20 outputs the binary data of the ARGB values of each pixel address making up a specific image to the VRAM 25, then the VRAM 25 outputs those data to the display portion 26.

The display portion 26 has a backlight 26a, an image display liquid crystal 26b, and a parallax barrier liquid crystal 26c. The backlight 26a is provided with a fluorescent lamp, a light-guiding plate, or a diffuser that is not shown in the drawing. The image display liquid crystal 26b is a liquid crystal cell that is made of a glass substrate, transparent electrodes, a polarizing film, liquid crystal, and spacers, for example, that are not shown in the drawing. A color filter is disposed on this liquid crystal. Further, the image display liquid crystal 26b also is a liquid crystal cell having the same configuration as the parallax barrier liquid crystal 26c. The image display liquid crystal 26b and the parallax barrier liquid crystal 26c are configured such that when the binary data of the ARGB values are obtained from the VRAM 25, they drive the electrodes of the pixel addresses corresponding to those data to produce an image. Further, the image display liquid crystal 26b and the parallax barrier liquid crystal 26c are both so-called normal white displays in which the transmittance drops when voltage is applied to the pixel electrodes.

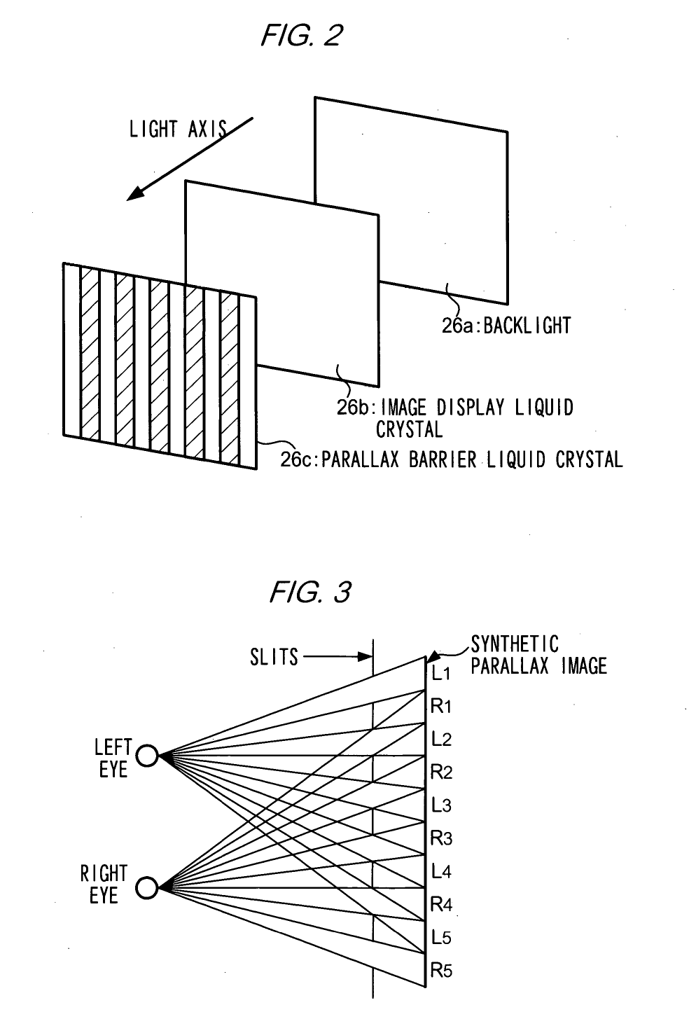

FIG. 2 is a perspective view showing the positional relationship among the backlight 26a, the image display liquid crystal 26b, and the parallax barrier liquid crystal 26c, as well as a representation of the stripes that are displayed on the parallax barrier liquid crystal 26c in the display portion 26 of the embodiment. As shown in FIG. 2, in the display portion 26 the backlight 26a, the image display liquid crystal 26b, and the parallax barrier liquid crystal 26c are disposed parallel to the light axis direction. As will be discussed in further detail later, the image display liquid crystal 26b displays a synthetic parallax image in which stripe-shaped pixel groups that are obtained by partitioning the parallax images having parallax with respect to one another are arranged in alternating rows in the horizontal direction. Conversely, the parallax barrier liquid crystal 26c is configured so as to display black stripes arranged parallel to and at the same spacing as the stripe-shaped pixel groups that are incorporated in the synthetic parallax image over its entire surface (hereinafter, these are referred to as “slits”). Thick slits are shown in FIG. 2 in order to express them in the drawing, but in practice numerous narrow slits are arranged in rows. When an observer views the synthetic parallax image that is displayed on the image display liquid crystal 26b from the side on which the parallax barrier liquid crystal 26c is located, the right eye parallax image incorporated into the synthetic parallax image is formed only on his right eye, and similarly the left eye parallax image that has been incorporated is formed only on his left eye, thereby achieving a stereoscopic presentation of the synthetic parallax image.

This principle is described in further detail in reference to FIG. 3. As shown in FIG. 3, the synthetic parallax image that is displayed on the image display liquid crystal 26b is constituted by stripes of pixels L1 to L5 that are obtained by partitioning the left eye parallax image and stripes of pixels R1 to R5 that are obtained by partitioning the right eye parallax image arranged in alternating rows in the horizontal direction. The light that is generated from the pixels of L1 to L5 is blocked by the slits and thus does not arrive at the right eye R, and the light that is generated from the pixels of R1 to R5 is blocked by the slits and thus does not arrive at the left eye L. Thus, only the left eye parallax image is formed on the left eye L and only the right eye parallax image is formed on the right eye R. Also, as will discussed later, because the left eye parallax image and the right eye parallax image have been created so as to have a constant parallax with respect to one another, the physiological action of the viewer's brain that is caused by this parallax results in the viewer perceiving the display content in three dimensions.

<Operation of the Embodiment>

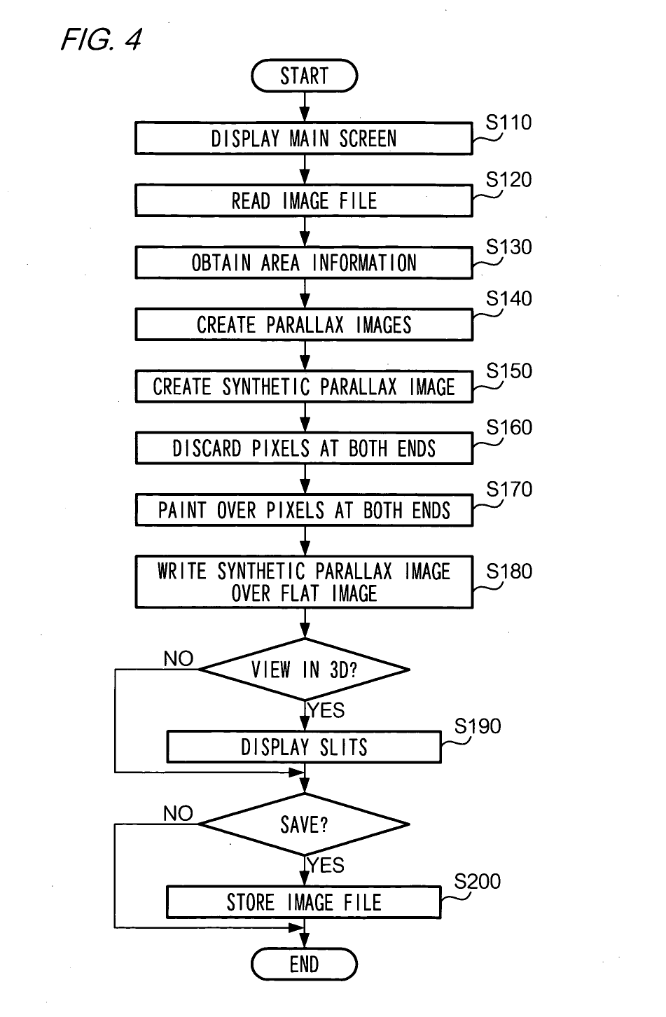

The operation of the present embodiment is described below. FIG. 4 is a flowchart showing the operation of the present embodiment.

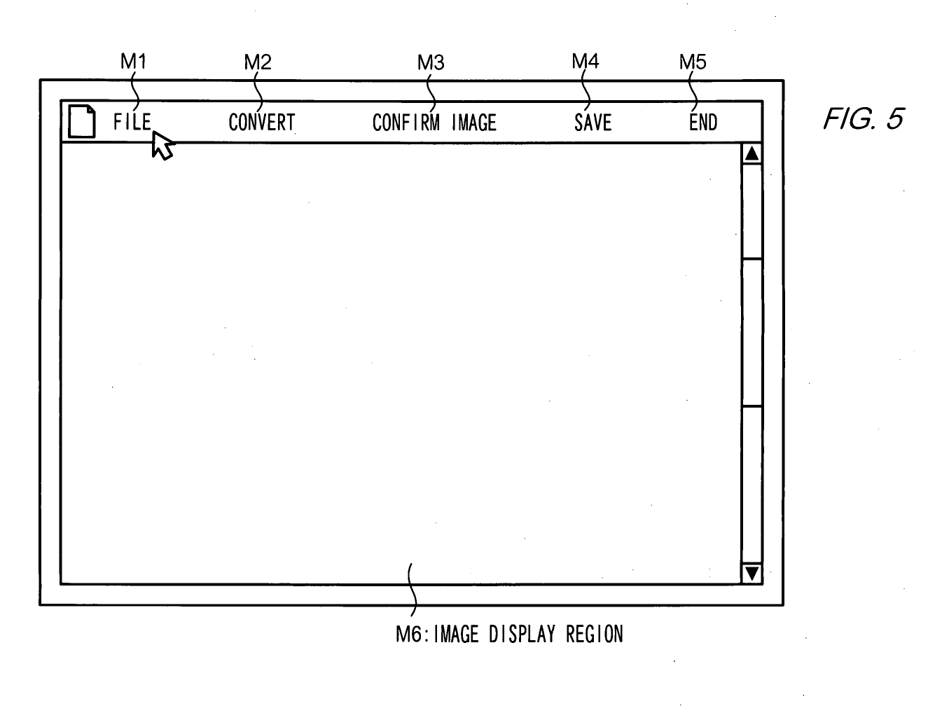

First, when the stereoscopic image display device is activated, the CPU 20 displays a main screen on the image display liquid crystal 26b of the display portion 26 (S110). It should be noted that at this point, voltage is not being applied to the electrodes of the pixels of the parallax barrier liquid crystal 26c, so that all of the pixels of the parallax barrier liquid crystal 26c are transparent. FIG. 5 shows the configuration of the main screen. At an upper portion of the main screen are arranged a file read button M1, a conversion button M2, an image confirm button M3, a save button M4, and an end button M5. An image display region M6 is provided in the center portion of the screen.

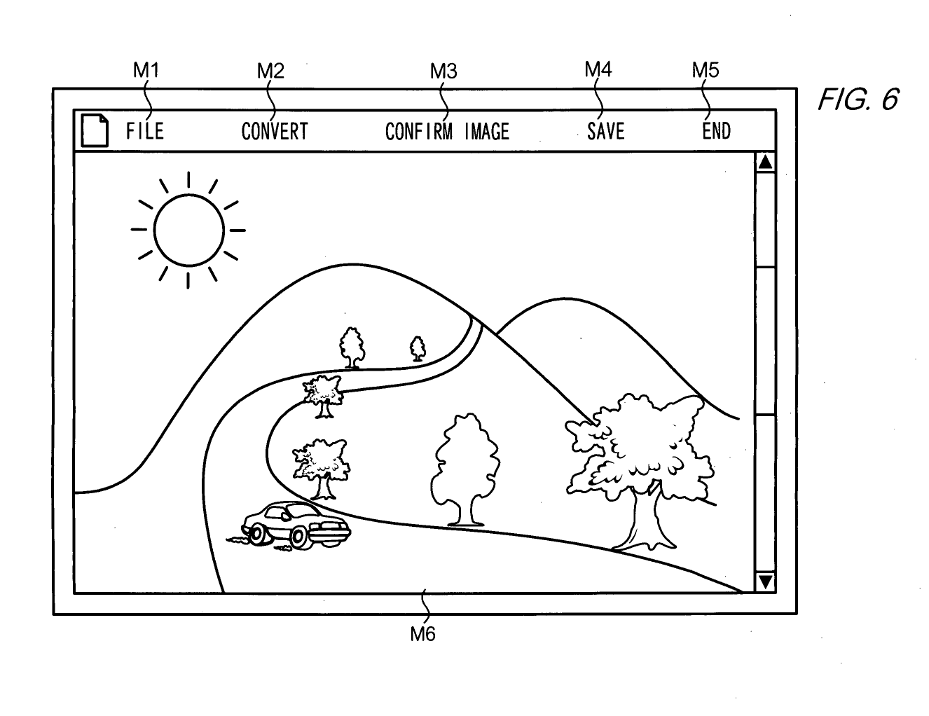

The CPU 20 reads a flat image file that has been selected through operation of the operation unit 24 from the HD 23 and displays this flat image on the image display liquid crystal 26b (S120). The flat image file is selected by clicking on the file read button M1 on the main screen to advance to a file selection screen and selecting a desired file from this screen. When this operation is performed, a flat image such as the one shown in FIG. 6 is displayed on the image display liquid crystal 26b.

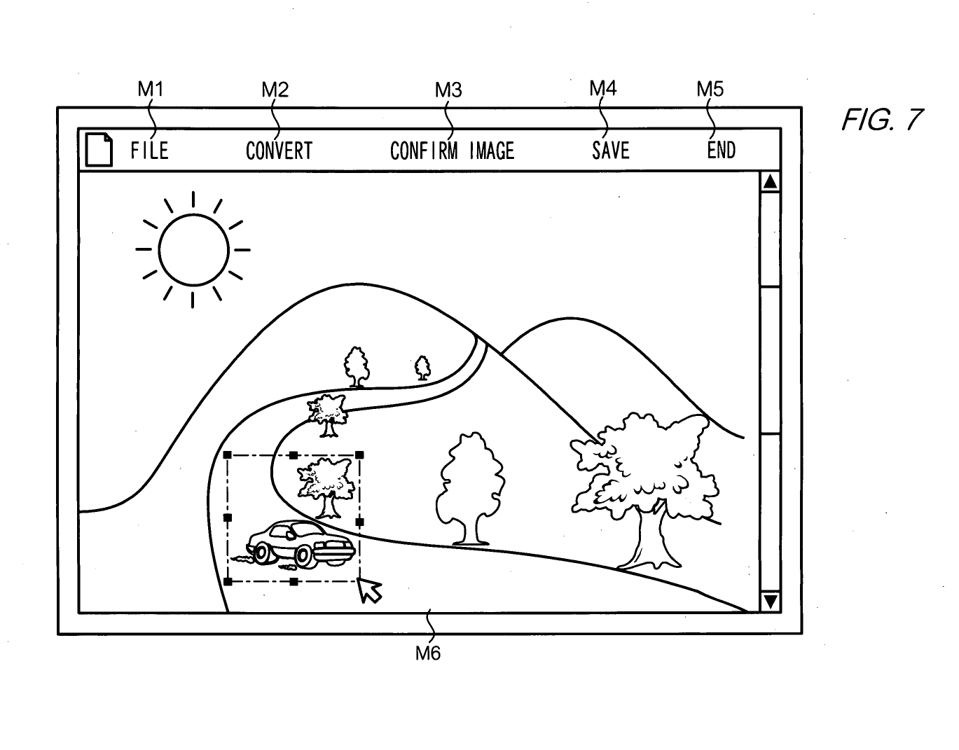

Next, the CPU 20 obtains area information in accordance with an operation performing on the operation unit 24 (S130). As shown in FIG. 7, this operation is effected by performing a drag-and-drop operation with the mouse 24a to surround a region to be provided in stereoscopic presentation within a rectangular region. In the case of FIG. 7, an area surrounding an automobile and the tree behind it rendered as a flat image has been designated as a stereoscopic presentation region. Further, the above area information is information for specifying the designated stereoscopic presentation region within that flat image. Specifically, it is the coordinates of the corners of the rectangular region designated by the drag-and-drop operation. The area information is stored on the RAM 21. After designating the stereoscopic presentation region with the drag-and-drop operation, the operator then clicks on the conversion button M2 on the main screen.

When the conversion button M2 has been clicked, the CPU 20 creates the right eye parallax image and the left eye parallax image of the stereoscopic presentation region (S140). This creation operation will be described in further detail below. First, the left eye parallax image and the right eye parallax image are images that have a constant parallax with respect to one another, that is, they are two images obtained by shifting the location of the pixel groups for rendering the same object in the image to the left and the right. To create these two images it is necessary to specify the “shift range” of the pixel groups rendering that object as a quantitative value. The greater the shift range of the object, the more forward the viewer will perceive that object. The general trend is for closer objects to have a higher degree of vividness than more distant objects. Accordingly, the present embodiment provides an algorithm that employs this general trend in order to calculate the “shift range.” Here, this algorithm is employed to convert the ARGB values of the pixels of the stereoscopic presentation region, of the ARGB values of the pixels depicting a flat image, in order to create parallax images having parallax with respect to one another from the flat image data.

That is, in this embodiment, values serving as the “depth values” that quantitatively indicate how deep a particular pixel is located in the stereoscopic presentation region that has been specified based on the vividness of that pixel are calculated, and the regions in which many high depth values are dispersed and the regions in which many low depth values are dispersed are separated. Next, the depth values of the pixels in each of the segregated regions are averaged and the shift ranges for each of the segregated regions are set so as to be substantially inversely proportional to those averaged depth values. The data of the pixels making up the stereoscopic presentation region of the flat image are shifted to the left by that shift range to create a right eye parallax image, and conversely, the data of those pixels are shifted to the right by that shift range to create a left eye parallax image. As a result, regions of a higher average depth value will have greater left and right eye parallax and in turn the viewer will perceive that region projecting more forward from the screen.

Returning to the description of the flowchart of FIG. 4, after the CPU 20 has created the left eye parallax image and the right eye parallax image, it synthesizes those parallax images to create a synthetic parallax image (S150). This synthesis is achieved by arranging the stripe-shaped pixel groups that are obtained by partitioning both eye parallax images in the horizontal direction according to the width of the slits into alternating rows in the horizontal direction.

Next, of those regions in which ARGB values of the pixels have not been specified, the CPU 20 discards the regions at the left and right ends of the synthetic parallax image that are located outside the designated stereoscopic presentation region (S160). As mentioned above, the synthetic parallax image is produced by synthesizing the left eye parallax image and the right eye parallax image, but this leads to the problem of regions in which pixel ARGB values are not specified appearing in portions of the left and right ends of synthetic parallax images produced in this manner.

This problem will be described further. In this embodiment, the left eye parallax image is obtained by shifting the pixels of the flat image to the right and the right eye parallax image is obtained by shifting those pixels to the left, but obviously the ARGB values of pixels outside the left and right ends of the flat image cannot be specified. This is because pixels do not exist there to begin with.

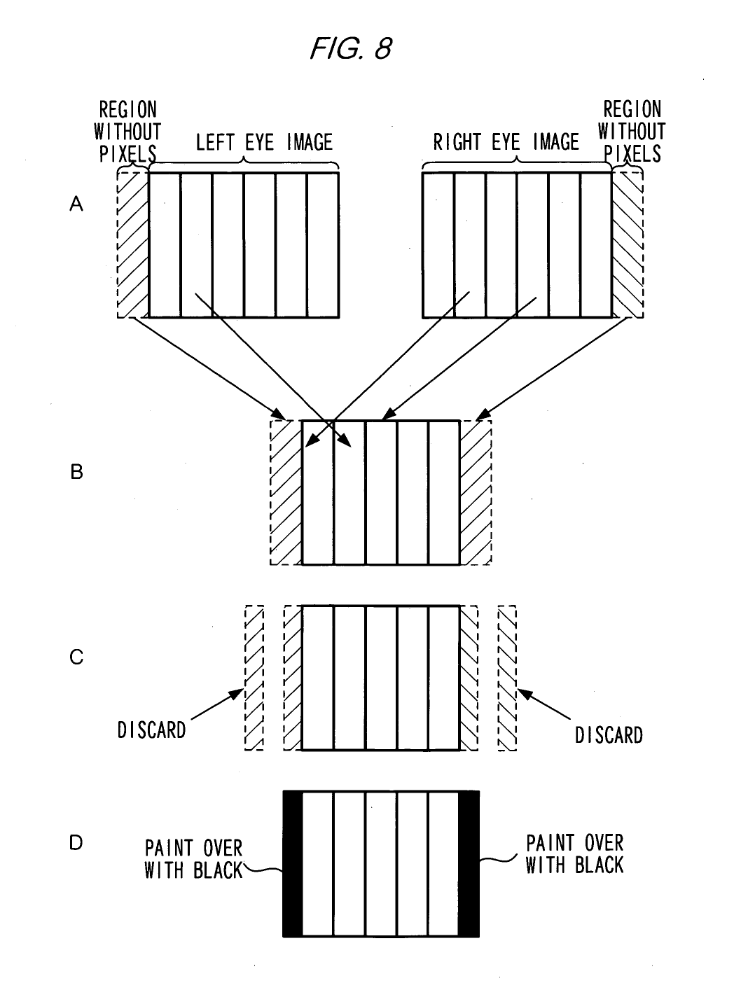

Consequently, a region in which the pixels that should be shifted do not exist in the original flat image and thus the ARGB values of the pixels cannot be specified appears in a portion of the left end of the left eye parallax image. Similarly, a region in which the pixels that should be shifted do not exist in the original flat image and thus the ARGB values of the pixels cannot be specified appears in a portion of the right end of the right eye parallax image (see FIG. 8A). Furthermore, because the synthetic parallax image is an image in which the stripe-shaped pixel groups that are obtained by partitioning both eye parallax images in the horizontal direction are arranged in alternating rows in the horizontal direction, regions in which pixel ARGB values cannot be specified, that is, regions in which there are no pixels, will naturally be present in a portion of the left and right ends of the synthetic parallax image (see FIG. 8B).

Consequently, for example if the regions in which pixel ARGB values have not been specified in the left and right ends extend by ten pixels beyond the left and right ends of the stereoscopic presentation region, then the CPU 20 discards this ten-pixel region at both ends (see FIG. 8C).

Further, of those regions at the left and right ends of the synthetic parallax image in which pixel ARGB values have not been specified, the CPU 20 also fills in the regions located to the inside of the designated stereoscopic presentation region with black (S170). As mentioned above, regions in which pixel ARGB values are not specified appear in a portion of the left and right ends of the synthetic parallax image. These regions may extend into the stereoscopic presentation region. Consequently, for example if the regions in which pixel ARGB values have not been specified are present up to ten pixels inward from the left and right ends of the stereoscopic presentation region, then the CPU 20 uniformly paint over this interior ten-pixel region with black (see FIG. 8D). By doing this, the left and right end portions of the stereoscopic presentation region can be kept from giving an unnatural impression.

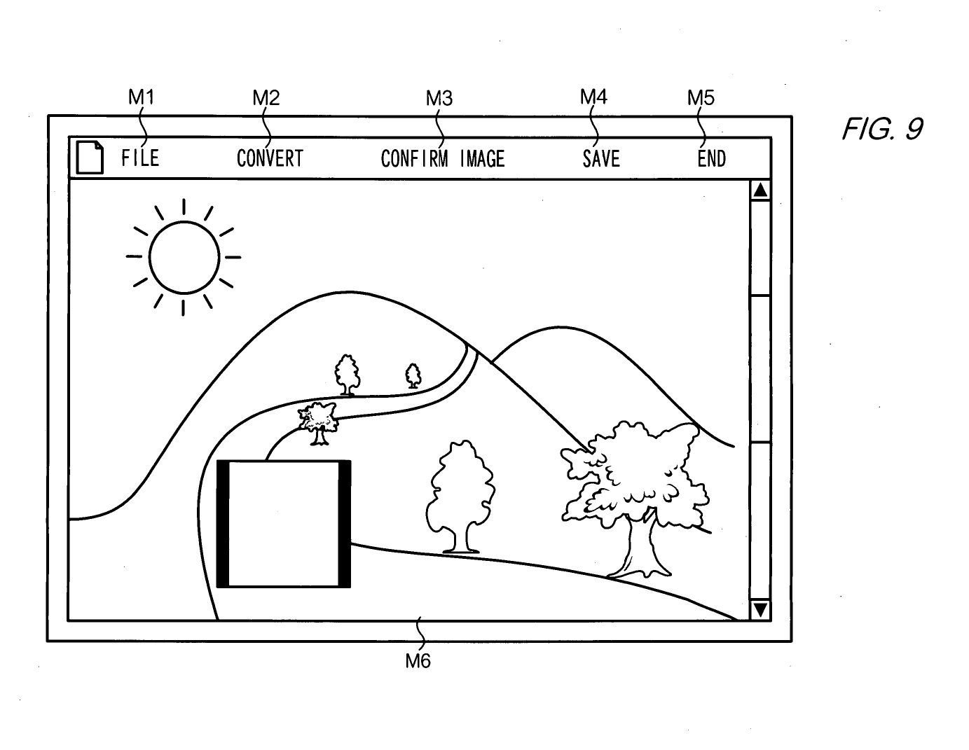

The CPU 20 writes the synthetic parallax image that is obtained by correcting the pixels at both ends as mentioned above over the flat image (S180). The CPU 20 specifies a region in which to embed the synthetic parallax image based on the area information stored on the RAM 21. Here, the pixels at both ends of the synthetic parallax image have been corrected and thus this region perfectly matches the stereoscopic presentation region that was designated by the drag-and-drop operation (see FIG. 9). Again, it is possible to keep the left and right end portions of the overwritten synthetic parallax image from giving an unnatural impression.

When the operator would like to actually view the synthetic parallax image that has been written over the flat image as a stereoscopic presentation, he clicks the image confirm button M3 on the main screen. The CPU 20 receives this operation and displays the slits over the entire surface of the parallax barrier liquid crystal 26c (S190). As discussed above, the slits are black stripes displayed at the same pitch as the stripes arranged in alternating rows in the synthetic parallax image. Thus, when the slits are displayed, the pixels of the right eye parallax image incorporated into the synthetic parallax image are guided into the operator's right eye only and the pixels of the left eye parallax image are guided into his left eye only, and as a result a stereoscopic presentation of the synthetic parallax image is achieved.

The operator confirms the content of the image through that stereoscopic presentation, and if he decides he would like to save the flat image written over by that synthetic parallax image, he then clicks the save button M4 on the main screen. The CPU 20 receives this operation and stores the data of the flat image over which that synthetic parallax image has been written on the HD 23 (S200).

When the operator clicks on the end button M5 on the main screen, the CPU 20 ends all of the process operations.

According to this first embodiment described above, some regions of a flat image are converted into stereoscopic images, and by writing those over that flat image it is possible to easily create the data of an image that partially includes stereoscopic images. Also, in the present embodiment, only the regions designated by an operator through the drag-and-drop operation are converted into stereoscopic images. The operator can thus freely designate regions to be provided as stereoscopic presentations and obtain images in which those designated regions are provided as stereoscopic presentations with ease.

### B SECOND EMBODIMENT

<Configuration of the Embodiment>

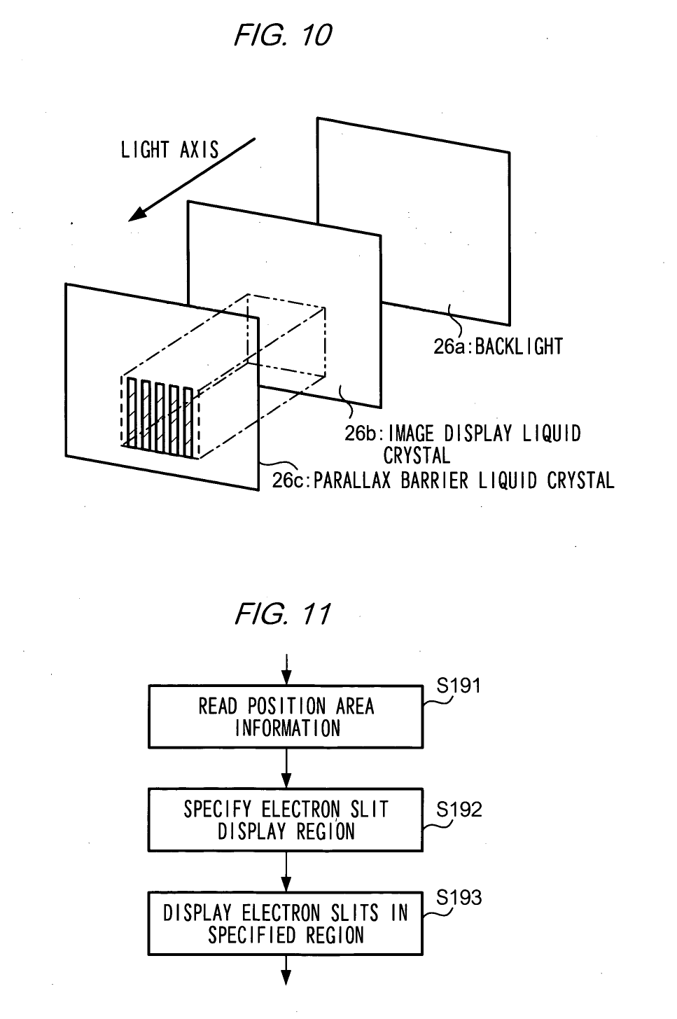

The configuration of the stereoscopic image display device of this embodiment is the same as that of the first embodiment, and thus will not be described again with reference to the drawings. However, the function of the parallax barrier liquid crystal 26c in this embodiment is different from that of the above embodiment, and thus this aspect will be described with reference to FIG. 10. FIG. 10 is a perspective view showing the positional relationship among the backlight 26a, the image display liquid crystal 26b, and the parallax barrier liquid crystal 26c, as well as the content displayed on the parallax barrier liquid crystal 26c in the display portion 26 of this embodiment. The display portion 26 of this embodiment is identical to that of the first embodiment in that the backlight 26a, the image display liquid crystal 26b, and the parallax barrier liquid crystal 26c are disposed parallel to the optical axis direction, but it is configured so as to display the slits only in a specific region rather than over the entire area of the parallax barrier liquid crystal 26c. Control of the region in which the slits are displayed is performed by the CPU 20.

<Operation of the Embodiment>

The operation of the present embodiment is described below. FIG. 11 is a flowchart showing the characteristic operation of the present embodiment.

In this embodiment, the operation up to designation of the stereoscopic presentation region by the operator, creation of a synthetic parallax image of this region, and writing this synthetic parallax image over the stereoscopic presentation region of the original flat image are the same as in the steps 110 to 170 discussed above. The difference with the first embodiment lies in the operation from the point that the image confirm button M3 on the main screen is clicked.

An operator who would like to view a stereoscopic presentation of the synthetic parallax image written over the flat image clicks on the image confirm button M3 on the main screen. The CPU 20 receives this operation and first reads the area information from the RAM 21 (S191). Next, the CPU 20 specifies the region in which to display the slits based on that area information (S192). The CPU 20 then displays the slits in that specified region of the parallax barrier liquid crystal 26c (S193).

As mentioned above, the slits are displayed at the same pitch as the stripes alternately arranged in rows in the synthetic parallax image, and thus the pixels of the right eye parallax image incorporated into the synthetic parallax image are guided into only the operator's right eye and the pixels of the left eye parallax image of the same are guided into only the operator's left eye, producing a stereoscopic presentation of that overwritten synthetic parallax image. The difference with the first embodiment is that here the CPU 20 controls the region in which the slits are displayed on the parallax barrier liquid crystal based on the area information stored on the RAM 21. That is, the region of the image display liquid crystal 26b overwritten by the synthetic parallax image matches the region in which the slits are displayed on the parallax barrier liquid crystal 26c. By performing this control, it is possible to allow all of the light emitted from regions other than the region overwritten by the synthetic parallax image to pass through the parallax barrier liquid crystal 26c, thereby allowing the observer to perceive the flat image portions that have not been overwritten by the synthetic parallax image as brighter and clearer.

### C MODIFIED EXAMPLES

Embodiments of the invention are described above, but it should be understood that those embodiments only serve as illustrative examples, to which various modifications can be added. Specific examples of conceivable modified examples are discussed below.

### C-1 Modified Example 1

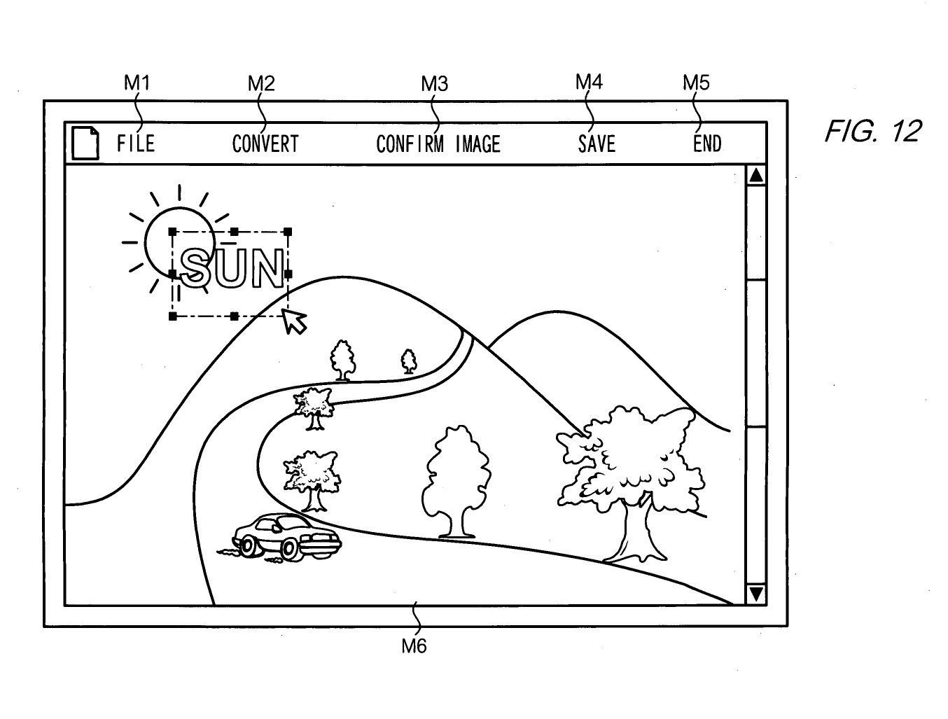

The configuration of the foregoing embodiment is such that when a specific region to be provided in stereoscopic presentation is designated through the drag-and-drop operation shown in FIG. 7, the CPU 20 calculates the shift range of the object for creating a left eye parallax image and a right eye parallax image based on the depth values of the pixels calculated from the vividness of all of the pixels in that region. However, as shown in FIG. 12, there are cases in which it is desirable to render single color characters in the flat image and produce a stereoscopic presentation of those characters only. In this case, when a region to be provided as a stereoscopic presentation is designated through the above operation, a synthetic parallax image having a constant shift range is created for those pixels other than the characters in that region, such as in the case of FIG. 12, the pixels depicting a portion of the sun and the pixels depicting the sky in that region. If the flat image overwritten by the synthetic parallax image is then viewed through the slits, the border between the region of the stereoscopic presentation region that was designated through the drag-and-drop operation and the region outside of this range in which the flat image is unchanged will give the viewer an the impression of being unnatural.

To avoid this, it is possible to adopt a configuration in which an operator who has designated a region to be provided as a stereoscopic presentation can further designate a specific color in that region, and for the CPU 20, after creating a parallax image having the above shift range, to change the alpha value of the ARGB value of pixels having a color other than the designated color to zero in order to make those pixels transparent. When the synthetic parallax image processed in this fashion is then written over the original flat image, then the pixels other than those of the designated color become transparent, and thus it is possible for the viewer to view only the object having the specified color in three dimensions. Conversely, it is also possible to change the alpha value of pixels of the designated color to zero to make those pixels transparent.

### C-2 Modified Example 2

Modified Example 1 describes a case in which, when an operator designates a region to be provided as a stereoscopic presentation additionally further designates a specific color, the CPU 20 changes the alpha value of pixels other than the pixels having that designated color in the parallax image to zero, but it is also possible for the operator to instead designate a specific depth value. With this configuration, the CPU 20 calculates depth values from the vividness of the pixels in the designated region and then determines whether or not these calculated depth values match a designated depth value. If there is a match, the CPU 20 changes the alpha value of that pixel to zero. The resulting effect is the same as the effect when a color is designated.

### C-3 Modified Example 3

In the foregoing embodiment, the configuration was such that when the operator designates a stereoscopic presentation region through a drag-and-drop operation, the image within this region is made into a three-dimensional image, but it is also possible to adopt a configuration in which, rather than the operator designating a stereoscopic presentation region through a drag-and-drop operation, areas obtained by partitioning the screen into fourths or eighths are set in advance, and the area selected from among these by the user is then automatically specified as the stereoscopic presentation region, and the synthetic parallax image is created.

### C-4 Modified Example 4

The display portion 26 of the foregoing embodiment is provided with an image display liquid crystal 26b and a parallax barrier liquid crystal 26c, and the parallax barrier liquid crystal 26c displays slits in correspondence with control by the CPU 20 in order to achieve a stereoscopic presentation of the image displayed on the image display liquid crystal 26b. However, it is not essential that the parallax barrier liquid crystal 26c is provided, and in its place it is possible to use a detachable film that forms slits at the same pitch as the stripe-shaped pixel groups displayed on the image display liquid crystal 26b in order to achieve a three dimensional presentation. If such a configuration is adopted, then the operator attaches the film to the front surface of the image display liquid crystal 26b when he would like to confirm a three-dimensional rendering of the synthetic parallax image written over the flat image, and views that image through this film.

### C-5 Modified Example 5

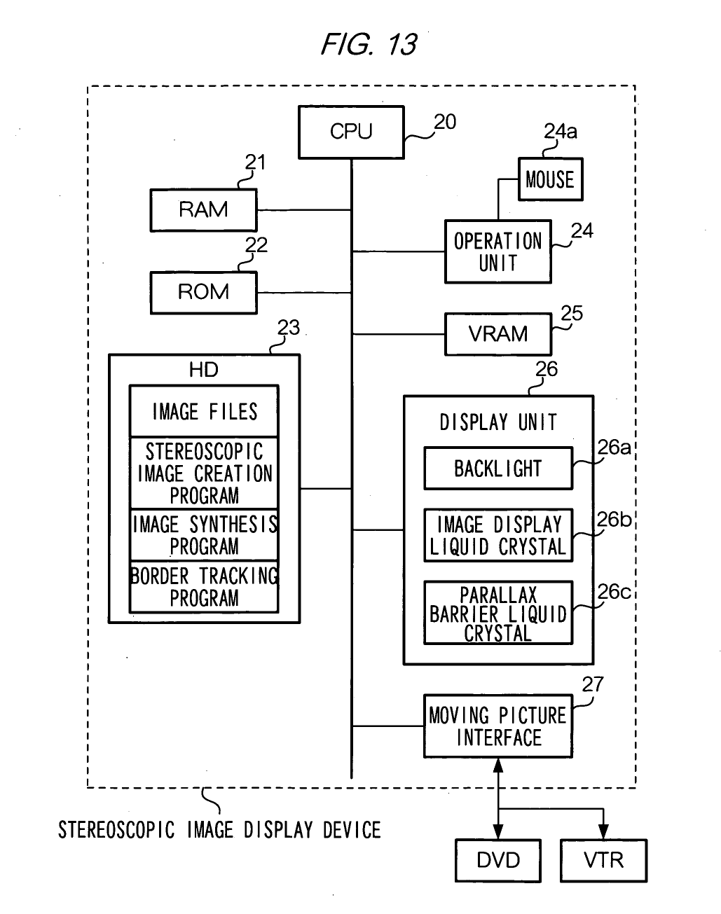

In the foregoing embodiment, the configuration is for producing three-dimensional images of still images only, but it is also possible to adopt the operation procedure of the foregoing embodiment to produce stereoscopic presentations for each frame of moving image data. For example, as shown in the block diagram of FIG. 13, in addition to the configuration of the above embodiment, a moving picture interface 27 that can obtain moving picture data output from an outside DVD or VTR is further provided, and by storing a border tracking program that tracks the region on each frame in which a specific object is rendered on the HD 23, the above implementation becomes possible.

The specific operation procedure of a system having this configuration is described. When the image data of each frame that has been input to the moving picture interface 27 has been stored on the RAM 21, the CPU 20 displays the image of the initial frame on the image display liquid crystal 26b. Then, when the operator selects a specific object in that image to serve as the stereoscopic presentation region, the CPU 20 uses the function of the border tracking program to first specify the border of that specific object and then performs processing to automatically track the border of that specific object from the images of the second frame onward. The CPU 20 then creates an image of a frame overwritten by the synthetic parallax image of the specific object in accordance with the procedure of steps 140 to 180, and outputs the image of the frame to the image display liquid crystal 26b. This series of operations is continued for each frame so that the specific object can be presented in three dimensions in the moving picture. It should be noted that it is necessary to display slits on the parallax barrier liquid crystal 26c in order to achieve a stereoscopic presentation, and naturally it is possible for the CPU 20 to control the parallax barrier liquid crystal 26c so as to display the slits over the entire area of the parallax barrier liquid crystal 26c or so that the region in which the specific object is displayed matches the region in which the slits are displayed.

### C-6 Modified Example 6

It is not necessary for moving picture data to be provided for three-dimensional viewing to be output from an outside DVD or VTR. For example, it is possible to store moving picture files having an extension such as avi, drc, mov, or swf on the HD 23 in advance, and when reading out those files in order to reproduce a moving picture to achieve a stereoscopic presentation of a specific object in that moving picture by processing the image of each frame as described in Modified Example 5.

### C-7 Modified Example 7

In the foregoing embodiment, a three-dimensional rendering is achieved using a parallax barrier by displaying a synthetic parallax image in which stripe-shaped pixel groups obtained by partitioning the left eye parallax image and the right eye parallax image are arranged in alternating rows in the horizontal direction as the stereoscopic image, but synthetic parallax images for three-dimensional viewing can also be created through an anaglyph. That is, the left eye parallax image is rendered using red pixels and the right eye parallax image is rendered using blue pixels and these images are overlapped to produce a synthetic parallax image. A blue film is placed in front of the viewer's right eye and a red film is placed in front of his left eye so that only the left eye image rendered in red pixels is formed on his left eye and only the right eye image rendered in blue pixels is formed on his right eye, thereby producing a stereoscopic image. This configuration allows a synthetic parallax image to be created by overlaying the left eye parallax image and the right eye parallax image, and thus it is not necessary to perform processing in order to arrange the stripe-shaped partitioned pixel groups in alternating rows. It is also not necessary to provide a parallax barrier liquid crystal for the purpose of blocking some of the viewer's field of view.

### C-8 Modified Example 8

In Modified Example 7, the left eye parallax image is rendered in red pixels and the right eye parallax image is rendered in blue pixels, but it is also possible to adopt a configuration in which the polarizing directions of the pixels making up these parallax images are perpendicular. Thus, a stereoscopic presentation can be achieved by displaying a synthetic parallax image that synthesizes these parallax images and by the observer wearing polarization spectacles.

### C-9 Modified Example 9

In the foregoing embodiment, a region in which pixel ARGB values are not specified appears at the left and right ends of the synthetic parallax image, and if these regions are outside of the stereoscopic presentation region specified by the drag-and-drop operation, then a procedure to discard the region is performed. However, it is also possible to set the alpha value of the ARGB values of the pixels in that region to zero in order to make those pixels transparent. Further, in the foregoing embodiment if the region in which pixel ARGB values are not specified falls within the stereoscopic presentation region, then all of the pixels of that region are painted over with black, but it is also possible to remove the pixels of this region or to set the alpha value of the ARGB values of the pixels in that region to zero in order to make those pixels transparent.

It can be understood from this that when appearing outside of the stereoscopic presentation region, the pixels whose ARGB value has not been specified can be corrected using two different approaches, those being removing the pixels of that region or making those pixels transparent. When appearing within the stereoscopic presentation region, the pixels whose ARGB value has not been specified can be corrected using three different approaches, those being painting over the pixels of that region with black, removing those pixels, or making those pixels transparent. The reason for performing the processing of steps 160 and 170 in the foregoing embodiment is to keep the left and right end portions of the stereoscopic presentation region from giving an unnatural impression, and thus the pixels inside and outside the stereoscopic presentation region can be corrected using a combination of any of these approaches.

### C-10 Modified Example 10

In the foregoing embodiment, a specific region is selected from a flat image displayed in the image display region M6 of the display portion 26 through a drag-and-drop operation and a synthetic parallax image of this region is created and written over the original flat image. However, it is also possible to attach identifiers for specifying the target to be presented in three dimensions to the data of the flat image in advance and from these identifiers to automatically specify the target to be viewed in three dimensions and then create a synthetic parallax image.

A situation in which this application would be useful is when the links for specific image files (such as files having jpeg or gif extensions) to be displayed on a web page are described by HTML tags in a HTML (hyper text markup language) file for achieving that web page under control by a web browser. An example of this application is described in greater detail taking specific HTML tags as examples.

An HTML tag for displaying a specific image in a specific region of a web page is in general described as follows.
<IMG SRC=“X” WIDTH=“Y” HEIGHT=“Z”>
   In the case of such a description, the web browser first reads the image file from the memory region specified by “X” and then specifies the height of the display region of that image as “Y” and its width as “Z.” It then arranges the image that it has read within that specific display region on the web page.

It is thus possible to adopt a configuration in which an IMG tag is designated in advance as an identifier that specifies a target for three-dimensional processing, and when performing that designation, the CPU 20 creates a synthetic parallax image of the image read from the memory region specified by “X” according to the procedure of steps 140 to 170 and then displays this synthetic parallax image in the display region specified by “Y” and “Z.” It should be noted that it is necessary to display slits on a parallax barrier liquid crystal in order to achieve a stereoscopic rendering of that synthetic parallax image, and the region in which the slits are displayed preferably specified from the values “Y” and “Z” described as tag attributes.

An HTML tag for displaying a specific image in a specific location of a web page is in general described as follows.
<IMG SRC=“X” STYLE=“left:Y; top:Z>
   In the case of such a description, the web browser first reads the image file from the memory region specified by “X” and then specifies the left end of the display position of the image as “Y” and its upper end as “Z”. It then arranges that image that it has read within the specified display position on the web page.

Consequently, it is also possible to adopt a configuration in which an IMG tag is designated in advance as an identifier that specifies a target for three-dimensional processing, and when performing that designation, the CPU 20 creates a synthetic parallax image of the image read from the memory region specified by “X” according to the procedure of steps 140 to 170 and then displays that synthetic parallax image within the display location specified by “Y” and “Z”.

### C-11 Modified Example 11

In Modified Example 10, an IMG tag serves as an identifier that has been added to the data of a flat image in advance. As discussed above, the IMG tag specifies the location where the file of the image to be displayed on the web page is stored and also specifies the display position or the display region of that image in the web page. In contrast to this, it is also possible for an identifier for specifying a target of stereoscopic processing to serve as the tag relating to a specific moving picture file (such as a file having avi, dct, swf, or mov extension). This is described in detail with regard to a specific HTML tag example.

An HTML tag for displaying a specific AVI or QuickTime moving image in a specific region of a web page has the following general description.
<EMBED SRC=“X” WIDTH=“Y” HEIGHT=“Z”>
   In the case of such a description, the web browser first reads a moving picture file having an avi, mov, or QT extension, for example, from the memory region specified by “X” and then specifies the width of the display region of that moving picture as “Y” and its height as “Z.” It then consecutively reproduces the image of each frame of the moving picture file that it has read in that specific display region on the web page.

It is thus possible for an EMBED tag to be designated in advance as an identifier that specifies a target for stereoscopic processing, and when performing that designation, for the CPU 20 to create a synthetic parallax image for each frame of the moving picture file read from the memory region specified by “X” according to the procedure of steps 140 to 170 and then display those sequential synthetic parallax images in the display region specified by “Y” and “Z.” It should be noted that like in Modified Example 10, it is preferable for the display region in which the slits for producing a stereoscopic rendering of the synthetic parallax images are displayed to be specified from the values “Y” and “Z,” which are described as attributes of the tag.

### C-12 Modified Example 12

In Modified Example 11, an EMBED tag serves as an example of an identifier that has been added to the data of a flat image in advance. This tag specifies the location where the file of the moving image to be reproduced on the web page is stored and also specifies the display position or the display region of that moving image on the web page. In contrast to this, it is also possible for an identifier for specifying the target of stereoscopic processing to serve as a tag relating to a specific simple program file (such as a file having a class extension). This is described in detail with regard to an example of a specific HTML tag.

An HTML tag for displaying the result of executing a specific Java applet in a specific display region of a web page has the following general description.
<APPLET CODE=“X” WIDTH=“Y” HEIGHT=“Z”>
   In the case of such a description, the web browser first reads an applet file having a class extension from the memory region specified by “X” and then specifies the width of the display region of the applet result as “Y” and its height as “Z.” It then displays the result of executing that program in the specified display region of the web page.

It is thus possible for an APPLET tag to be designated in advance as an identifier that specifies a target for stereoscopic processing, and when performing that designation, for the CPU 20 to execute the applet read from the memory region specified by “X” and to create a synthetic parallax image of the result in accordance with the procedure of steps 140 to 170 and then to display that synthetic parallax image in the display region specified by “Y” and “Z.” It should be noted that like in Modified Example 11, it is preferable for the display region in which the slits for producing a stereoscopic rendering of the synthetic parallax image to be specified from the values “Y” and “Z,” which are described as attributes of the tag.

As described above, the present invention is furnished with a creation section that creates a stereoscopic image and a synthesis section that writes the stereoscopic image over a flat image, synthesizing the two images. Consequently, the person who will view the image can easily create, from the data of that flat image, the data of an image that shows a portion of that flat image in three dimensions and then view the synthesized image in which that stereoscopic image is embedded.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

1. A stereoscopic image display device comprising:
creation means that creates a stereoscopic image;
synthesis means that writes the stereoscopic image over a flat image, to obtain a synthesized image; and
display means that outputs the synthesized image.

2. A stereoscopic image display device comprising:
memory means storing flat images;
creation means that creates a stereoscopic image of a specific region of a flat image read from the memory means;
synthesis means that writes the stereoscopic image of the specific region over that specific region in the flat image, to obtain a synthesized image; and
display means that outputs the synthesized image.

3. The stereoscopic image display device according to claim 2, further comprising:
designation means that designates a specific region in the flat image;
wherein the creation means creates a stereoscopic image of the specific region of the flat image designated by the designation means.

4. The stereoscopic image display device according to claim 2,
wherein the creation means detects a region in which a specific object is displayed in the flat image, and creates a stereoscopic image of that detected display region; and
wherein the synthesis means writes the stereoscopic image of the region in which that specific object is displayed over the read flat image, to obtain a synthesized image.

5. The stereoscopic image display device according to claim 4,
wherein a plurality of the specific objects are included in the flat image.

6. The stereoscopic image display device according to claim 3,
wherein the creation means creates the stereoscopic image by converting the specific region of the flat image into a right eye parallax image and a left eye parallax image that have parallax with respect to one another and then arranging, in alternating rows, stripe-shaped pixel groups obtained by partitioning the right eye parallax image and the left eye parallax image.

7. The stereoscopic image display device according to claim 4,
wherein the creation means discards pixels residing in a predetermined region at both ends of the stereoscopic image.

8. The stereoscopic image display device according to claim 4,
wherein the creation means causes a color of pixels residing in a predetermined region at both ends of the stereoscopic image to be a uniform specific color.

9. The stereoscopic image display device according to claim 4,
wherein the creation means causes pixels residing in a predetermined region at both ends of the stereoscopic image to become transparent.

10. The stereoscopic image display device according to claim 6, further comprising:
view field blocking means that blocks a portion of a field of view of a left eye such that the right eye parallax image, which is incorporated as stripes in the stereoscopic image, is formed only on the right eye, and blocks a portion of a field of view of a right eye, which is incorporated as stripes in the stereoscopic image, such that the left eye parallax image is formed only on the left eye.

11. The stereoscopic image display device according to claim 10, further comprising:
control means that controls the operation of the view field blocking means such that a region in which a portion of the field of view is blocked matches a specific region of the designated flat image.
